(19) United States
(12) Patent Application Publication
(10) Pub. No.: US 2022/0214247 A1
(43) Pub. Date: Jul. 7, 2022

(54) Sensor Boss, Sensor Assembly and Exhaust System

(71) Applicant: Faurecia Emission Control Technologies (Shanghai) Co., Ltd, Shanghai (CN)

(72) Inventors: Gerard BERTRAN, Shanghai (CN); Chi-Hyoun LEE, Gyeonggi-do (KR); Vinothkumar SINGARAVEL, Bangalore (IN)

(21) Appl. No.: 17/568,418

(22) Filed: Jan. 4, 2022

(30) Foreign Application Priority Data
Jan. 4, 2021 (CN) 202110004859.X

(51) Int. Cl. G01M 15/10; F01N 13/00

(52) U.S. Cl. CPC G01M 15/102; F01N 13/008

(57) ABSTRACT

The present disclosure relates to a sensor boss, a sensor assembly and an exhaust system, wherein the sensor boss comprises a base and a fluid channel, the base comprises a base body and a mounting hole penetrating the base body, the mounting hole is used to install a sensor through it, the base body is used to fix the sensor boss on a fluid pipeline, and the fluid channel extends from an inlet end to an outlet end in a first direction to accommodate a probe of the sensor.

### TECHNICAL FIELD

The present disclosure relates to the exhaust field, in particular to a sensor boss, a sensor assembly and an exhaust system.

### BACKGROUND

In automobile exhaust system, sensors are usually installed to detect exhaust composition, temperature, flow and other parameters, so as to judge whether the engine and the exhaust system operate normally, whether the exhaust meets the requirements of emission regulations and so on.

In actual exhaust system, according to different emission requirements and spatial layout requirements, specific structures of the exhaust system are diverse, so that gas flow direction near the sensor is also different. However, the installation position of the sensor is generally limited by established assembly process and assembly tooling and cannot be changed easily, and the detection point of sensing probe of the sensor should preferably be within a certain angle range with the gas flow direction (defined as a sensing angle in the present disclosure), so that the gas can be sensed more accurately.

The method generally adopted in the prior art guides the gas flow through the setting of specially designed baffle or deflector, so as to keep the moving direction of the gas flow as consistent and stable as possible. However, for different exhaust channel structures, due to the different movement directions of gas flow, different deflectors and baffles need to be designed and tested for different exhaust channel structures, which is time-consuming and labor-consuming, resulting in a long R & D and testing cycle of products as well as high material and processing costs.

Therefore, there is a need in the art for a sensor boss, making the sensor can adapt to exhaust systems with different structures, and accurately sense gas under different gas flow moving environments, so as to make the exhaust system operate reliably.

### SUMMARY

An object of the present disclosure is to provide a sensor boss.

Another object of the present disclosure is to provide a sensor assembly.

Another object of the present disclosure is to provide an exhaust system.

A sensor boss according to one aspect of the present disclosure comprises a base, comprising a base body and a mounting hole penetrating the base body, wherein the mounting hole is used to install a sensor through it, and the base body is used to fix the sensor boss on an exhaust channel; and a fluid channel, extending from an inlet end to an outlet end in a first direction to accommodate a sensing probe of the sensor.

In one or more embodiments of the sensor boss, an angle between an axis of the mounting hole and the first direction is a sensing angle of the sensor.

In one or more embodiments of the sensor boss, the axis of the mounting hole is perpendicular to the first direction.

In one or more embodiments of the sensor boss, the first direction is a linear direction, and a length of the fluid channel is at least a diameter of the sensor.

In one or more embodiments of the sensor boss, the sensor boss comprises at least one mounting hole and at least one fluid channel, each mounting hole corresponds to one fluid channel, and each fluid channel is separated and independent from the others.

A sensor assembly according to another aspect of the present disclosure comprises a sensor boss, comprising a base and a fluid channel, wherein the base comprises a base body and a mounting hole penetrating the base body, and the fluid channel extends from an inlet end to an outlet end in a first direction; and a sensor, wherein the sensor is fixedly connected to the base penetrating through the mounting hole, and a sensing probe of the sensor is located in the fluid channel.

In one or more embodiments of the sensor assembly, an angle between a sensor axis and the first direction is a sensing angle of the sensor.

In one or more embodiments of the sensor assembly, the sensor axis is perpendicular to the first direction.

In one or more embodiments of the sensor assembly, a plurality of sensors are comprised, wherein the sensor boss is provided with a plurality of mounting holes and a plurality of fluid channels, each mounting hole is correspondingly installed with one sensor, and the sensing probe of the sensor is located in one fluid channel.

An exhaust system according to another aspect of the present disclosure comprises an exhaust channel and a sensor assembly according to any one of the above embodiments, wherein the base body is fixedly connected to a wall surface of the exhaust channel.

The progressive effects of the present disclosure comprise but are not limited to:

1. through the setting of the fluid channel, the exhaust movement in different flows and directions can be redirected in the fluid channel, so that there is an gas movement in a fixed gas movement direction near the sensing probe of the sensor, the measurement results of the sensor are accurate and reliable, and the exhaust system operates reliably;

2. compared with the structures of baffles or deflectors in the prior art, a simple structure and a good universality are achieved, exhaust systems with different structures, different gas flow movement spaces and different installation positions of sensors can be adapted to, and materials and processing costs can also be saved;

3. the exhaust still maintains good circulation and has little impact on the exhaust back pressure.

### BRIEF DESCRIPTION OF THE DRAWINGS

The above and other features, properties and advantages of the present disclosure will become more obvious through the following description in combination with the accompanying drawings and embodiments. It should be noted that the accompanying drawings are only examples, which are not drawn according to the conditions of equal scale and should not be used as a limitation on the protection scope actually required by the present disclosure.

FIG. 1 is a structural diagram of an exhaust system according to an embodiment.

FIG. 2 is a sectional view in direction A-A according to FIG. 1.

FIG. 3 is a sectional view in direction B-B according to FIG. 1.

FIG. 4 is a sectional view in direction C-C according to FIG. 1.

FIG. 5 is a structural diagram of a sensor boss according to an embodiment.

FIG. 6 is a structural diagram of a sensor assembly according to an embodiment.

### DETAILED DESCRIPTION

A variety of different embodiments or examples for implementing the subject technical proposal are disclosed below. In order to simplify the disclosure, specific examples of each element and arrangement are described below. Of course, these are only examples and do not limit the protection scope of the present disclosure.

In addition, the use of words such as “first” and “second” to define parts is only to facilitate the distinction between corresponding parts. Unless otherwise stated, the above words have no special meaning, so they cannot be understood as limiting the scope of protection of the present disclosure. For example, “one embodiment”, “an embodiment”, and/or “some embodiments” mean a feature, structure or characteristic related to at least one embodiment of the present application. Therefore, it should be emphasized and noted that “an embodiment” or “one embodiment” or “one or more embodiments” mentioned twice or more in different positions in this specification do not necessarily refer to the same embodiment. In addition, some features, structures or characteristics in one or more embodiments of the present application may be combined appropriately.

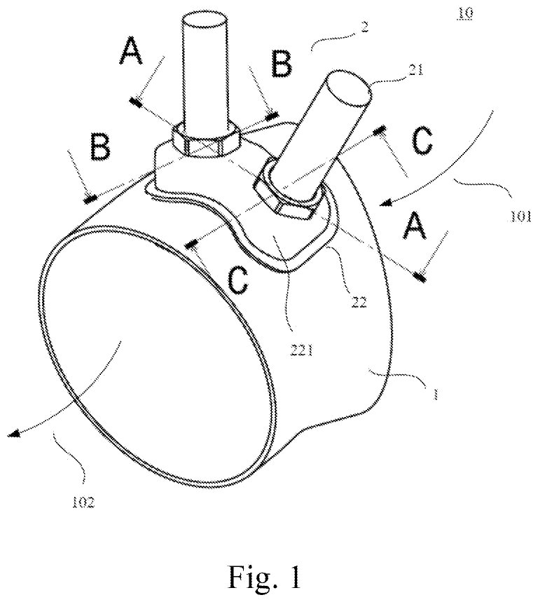

As shown in FIG. 1, the exhaust system 10 of an automobile may comprise an exhaust channel 1 and a sensor assembly 2. Upstream exhaust 101 enters the exhaust channel 1 through an inlet of the exhaust channel 1 and is discharged from an outlet of the exhaust channel 1 and becomes downstream exhaust 102. The direction from the upstream exhaust 101 to the downstream exhaust 102 is the direction from the upstream to the downstream of the exhaust channel 1. The specific structure of the exhaust channel 1 is located at an exhaust end cone of the exhaust system shown in FIG. 1, which is located at the exhaust end of the exhaust system, and is connected with the main part of the exhaust system through a flange, but not limited to this. It can be understood that the exhaust channel 1 can also be located at other positions of the exhaust system and has other structures, such as a pipe structure in the middle of the exhaust system, etc. The sensor assembly 2 comprises a sensor 21 and a sensor boss 22.

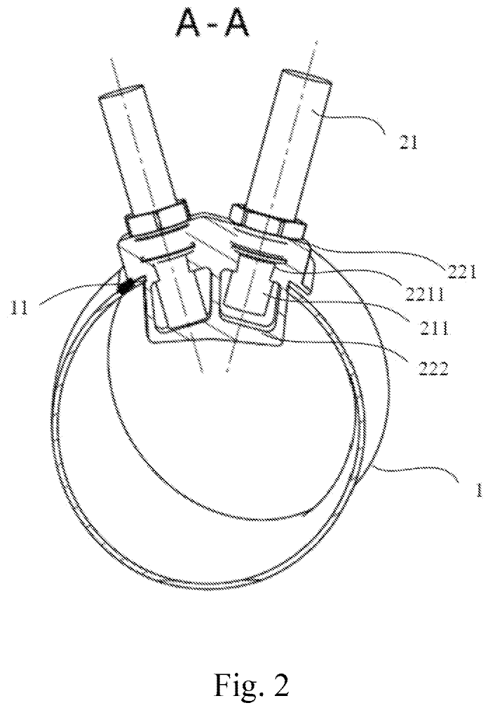

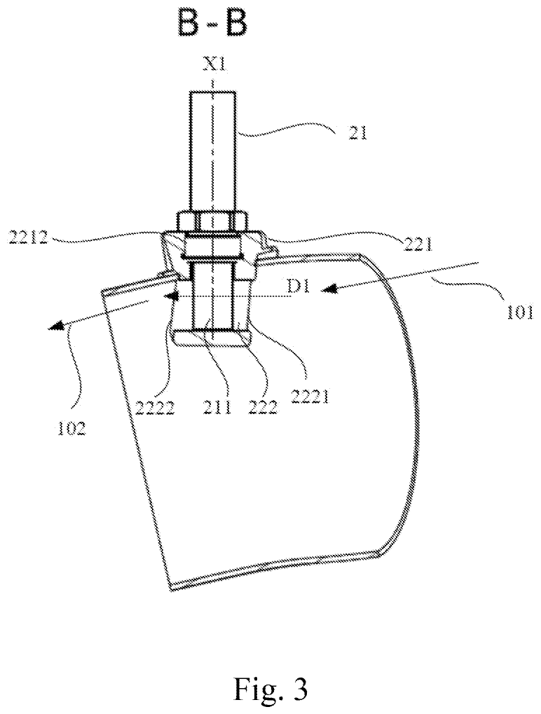

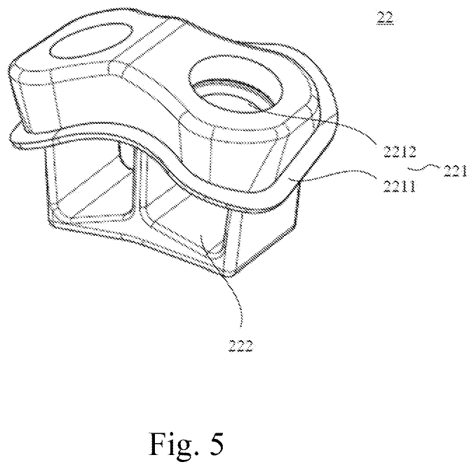

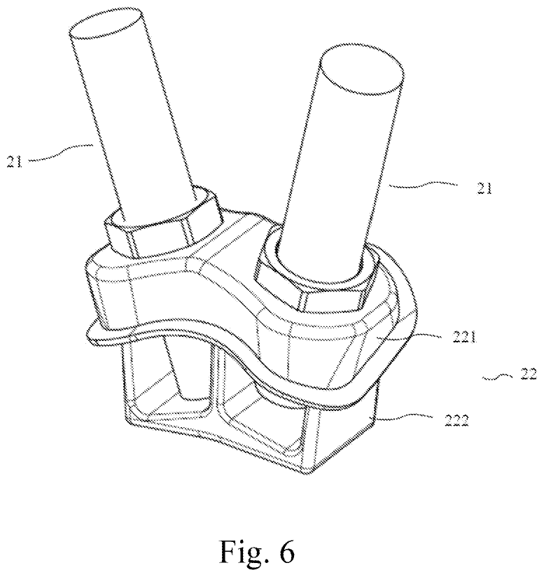

Referring to FIG. 5, the sensor boss 22 comprises a base 221 and a fluid channel 222.The base 221 comprises a base body 2211 and a mounting hole 2212 penetrating the base body 2211. The mounting hole 2212 is used to install the sensor 21 through it. As shown in FIG. 5, the sensor 21 is installed on the sensor boss 22 through the threaded structure of the mounting hole 2212. Referring to FIG. 1 to FIG. 4, the base body 2211 is fixedly connected with the wall surface of the exhaust channel 1 to fix the sensor boss 22 to the exhaust channel 1. The specific fixed connection structure can be that the wall surface of the exhaust channel 1 has an opening 11, and the base body 2211 is welded with the exhaust channel 1 to close the opening 11. Referring to FIG. 3 to FIG. 6, the fluid channel 222 extends from its inlet end 2221 to its outlet end 2222 in a first direction, and the fluid channel 222 contains a sensing probe 211 of the sensor 21. The fluid channel 222 may be integrally formed with the base 221, through process such as casting, but is not limited to it. For example, rapid forming methods such as machine tool processing or 3D printing may be used in small-scale manufacturing.

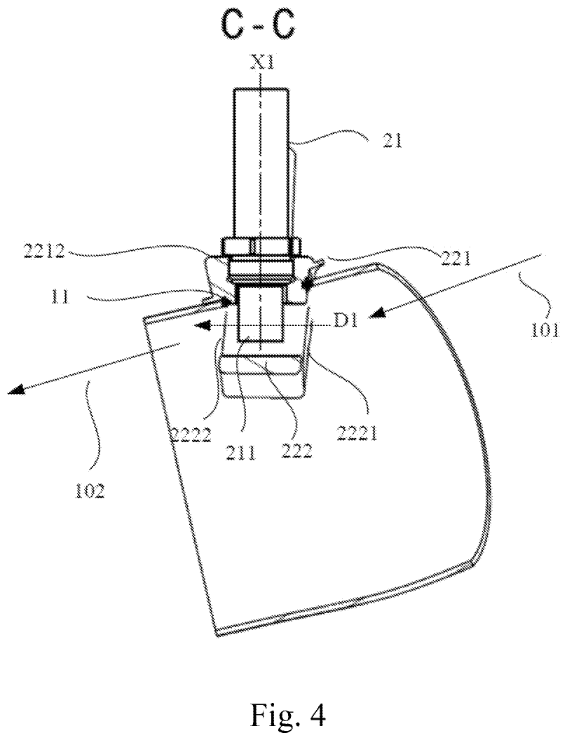

Referring to FIG. 3, FIG. 4 and FIG. 5, after the upstream exhaust 101 enters from the inlet of the exhaust channel 1, part of it flows into the fluid channel from the inlet end 2221 of the fluid channel 222 of the sensor boss 22, and flows in the fluid channel 222 along the extension direction of the fluid channel 222, that is, the first direction D1, so that the gas flow direction of the exhaust can be redirected and reoriented to ensure that the sensing probe 211 of the sensor 21 is at a fixed angle with the gas flow direction of the exhaust flowing nearby. The angle is preferably the sensing angle of the sensor. At present, the sensing angle is generally about 90°, and slightly variates with different specific sensors within a general error range of ±3°, so that the measurement result of the sensor is accurate and reliable, and the exhaust system operates reliably. However, it is not limited to this. For example, it is not ruled out that due to the limitation of installation environment and gas flow, if it is really difficult to make the angle as the sensing angle, it can be other angles, while it is necessary to study and test an algorithm for correcting the error. Through the setting of the fluid channel 222, the exhaust movement in different flows and directions can be redirected in the fluid channel 222, so that there is an gas flow movement in a fixed gas flow movement direction near the sensing probe 211 of the sensor 21, and the requirements of the sensing angle between the sensing probe and the gas flow movement direction can generally be meted. In addition, since the installation position of the sensor boss 22 is limited by the assembly process corresponding to the exhaust system, the sensor boss 22 described in the above embodiment has good universality, and can adapt to the corresponding exhaust gas flow movement of exhaust channels with different structures and different installation positions under the limitation of different assembly processes. At the same time, since the exhaust still flows from upstream to downstream in the fluid channel 222, adding the fluid channel 222 in the sensor boss thereby has little impact on the exhaust back pressure, so that there is no need to improve the exhaust back pressure of the exhaust system, which reduces the difficulty of system design. The inventor found that, especially for the sensor arranged at the outlet end of the exhaust channel 1 of the whole exhaust system, that is, when the base body 2211 in FIG. 1 is fixedly connected to the outlet end of the exhaust system, the effect of adopting the fluid channel 222 is particularly obvious due to the strong local swirling at the outlet end. Compared with the prior art structure of using a special baffle or deflector to guide the gas flow, the setting of the fluid channel 222 can not only obtain good sensor signals and make the measurement results accurate and reliable, but also has good universality, so that can adapt to outlet ends of different structures, make the structure of the exhaust system simple and easy to process, and save materials and processing costs.

Continuing to refer to FIG. 3 to FIG. 5, in one or more embodiments, the specific structure of the fluid channel 222 may be that the first direction of the fluid channel 222 is a linear direction, the length of the fluid channel is no shorter than the diameter of the sensor to fully accommodate the sensing probe of the sensor, the cross-sectional shape of the fluid channel 222 may be circular or square or other similar shapes, and the cross-sectional area of the fluid channel 222 needs to be larger than the cross-sectional area of the sensor to ensure that sufficient gas flow is not blocked by the sensor, so as to avoid the significant increase of exhaust back pressure and avoid less gas at the sensor sensing point affecting the signal strength of the sensor. Moreover, on the basis of little impact on exhaust back pressure, the effect of fluid channel 222 on gas reorientation is further optimized. At the same time, the structure of fluid channel 222 is relatively simple and easy to process.

Continuing to refer to FIG. 3, FIG. 4 and FIG. 5, in some embodiments, the sensor 21 is cylindrical, and the axis of the sensor 21 roughly coincides with the axis of the mounting hole 2212. For the sensor boss 22, the angle, between the axis of the mounting hole 2212 and the first direction of the extension of the fluid channel 222, is the sensing angle of the sensor 21.Preferably, as shown in FIG. 3 and FIG. 4, axis X1 of the sensor 21 is perpendicular to the first direction D1, that is, the axis of the mounting hole 2212 is also perpendicular to the first direction D1, so that the measurement result of the sensor 21 can be most accurate and reliable.

Continuing to refer to FIG. 1 to FIG. 6, in one or more embodiments, a single sensor boss 22 is integrated with two sensors 21. One base body 2211 has two mounting holes 2212 corresponding to two separate fluid channels 222, and each fluid channel 222 accommodates the sensing probe 211 of each sensor 21. This arrangement has high integration and compact structure, saving the installation space for the plurality of sensors. It can be understood that the above embodiment is only an example. Even for a plurality of sensors, one sensor boss 22 can meet the installation requirements, but the number of sensors is not limited to two, and can be flexibly adjusted according to the sensor arrangement of the exhaust system.

It can be seen from the above that the beneficial effects of adopting the sensor boss, the sensor assembly and the exhaust system introduced in the above embodiment comprise, but are not limited to,

1. through the setting of the fluid channel, the exhaust movement in different flows and directions can be redirected in the fluid channel, so that the gas flow direction of the exhaust meets the requirements of the sensing angle of the sensor, the measurement results of the sensor are accurate and reliable, and the exhaust system operates reliably;

2. compared with the structures of baffles or deflectors in the prior art, a simple structure and a good universality are achieved, exhaust systems with different structures, different gas flow movement spaces and different installation positions of sensors can be adapted to, and materials and processing costs can also be saved;

3. the exhaust still maintains good circulation and has little impact on the exhaust back pressure.

Although the above embodiments of the present disclosure are disclosed as above, they are not used to limit the present disclosure. Any person skilled in the art can make possible changes and modifications without departing from the spirit and scope of the present disclosure. Therefore, any amendments, equivalent changes and modifications, made to the above embodiments according to the technical essence of the present disclosure without departing from the technical proposal of the present disclosure, will fall within the protection scope that is defined in the claims of the present disclosure.

### REFERENCE NUMERALS

1—Exhaust channel

11—Opening

2—Sensor assembly

21—Sensor

211—Sensing probe of sensor

22—Sensor boss

221—Base

2211—Base body

2212—Mounting hole

222—Fluid channel

2221—Inlet end of fluid channel

2222—Outlet end of fluid channel

10—Exhaust system

101—Upstream exhaust

102—Downstream exhaust

1. A sensor boss, comprising:
a base, comprising a base body and a mounting hole penetrating the base body, wherein the mounting hole is used to install a sensor through it, and the base body is used to fix the sensor boss on an exhaust channel; and
a fluid channel, extending from an inlet end to an outlet end in a first direction to accommodate a sensing probe of the sensor.

2. The sensor boss of claim 1, wherein an angle between an axis of the mounting hole and the first direction is a sensing angle of the sensor.

3. The sensor boss of claim 2, wherein the axis of the mounting hole is perpendicular to the first direction.

4. The sensor boss of claim 1, wherein the first direction is a linear direction, and a length of the fluid channel is at least a diameter of the sensor.

5. The sensor boss of claim 1, wherein the sensor boss comprises at least one mounting hole and at least one fluid channel, each mounting hole corresponds to one fluid channel, and each fluid channel is separated and independent from the others.

6. A sensor assembly, comprising:
a sensor boss, comprising a base and a fluid channel, wherein the base comprises a base body and a mounting hole penetrating the base body, and the fluid channel extends from an inlet end to an outlet end in a first direction; and
a sensor,
wherein the sensor is fixedly connected to the base penetrating through the mounting hole, and a sensing probe of the sensor is located in the fluid channel.

7. The sensor assembly of claim 6, wherein an angle between a sensor axis and the first direction is a sensing angle of the sensor.

8. The sensor assembly of claim 7, wherein the sensor axis is perpendicular to the first direction.

9. The sensor assembly of claim 6, comprising a plurality of sensors, wherein the sensor boss is provided with a plurality of mounting holes and a plurality of fluid channels, each mounting hole is correspondingly installed with one sensor, and the sensing probe of the sensor is located in one fluid channel.

10. An exhaust system, comprising an exhaust channel and the sensor assembly, wherein the sensor assembly comprises:
a sensor boss, comprising a base and a fluid channel, wherein the base comprises a base body and a mounting hole penetrating the base body, and the fluid channel extends from an inlet end to an outlet end in a first direction; and
a sensor,
wherein the sensor is fixedly connected to the base penetrating through the mounting hole, and a sensing probe of the sensor is located in the fluid channel;
wherein the base body is fixedly connected to a wall surface of the exhaust channel.

11. The exhaust system of claim 10, wherein an angle between a sensor axis and the first direction is a sensing angle of the sensor.

12. The exhaust system of claim 11, wherein the sensor axis is perpendicular to the first direction.

13. The exhaust system of claim 10, wherein the sensor assembly comprises a plurality of sensors, wherein the sensor boss is provided with a plurality of mounting holes and a plurality of fluid channels, each mounting hole is correspondingly installed with one sensor, and the sensing probe of the sensor is located in one fluid channel.
